(19) United States
(12) Patent Application Publication
(10) Pub. No.: US 2026/0134702 A1
(43) Pub. Date: May 14, 2026

(54) PLANE ESTIMATION

(71) Applicant: Apple Inc., Cupertino, CA (US)

(72) Inventor: Seongdo Kim, Campbell, CA (US)

(21) Appl. No.: 19/436,356

(22) Filed: Dec. 30, 2025

Related U.S. Application Data
(62) Division of application No. 16/736,328, filed on Jan. 7, 2020, now abandoned.
(60) Provisional application No. 62/799,688, filed on Jan. 31, 2019.
(60) Provisional application No. 62/851,768, filed on May 23, 2019.

(51) Int. Cl. G06V 20/64; G06F 18/214; G06V 10/22; G06V 10/44

(52) U.S. Cl. CPC G06V 20/647; G06F 18/214; G06V 10/22; G06V 10/44

(57) ABSTRACT

A system or method extends a planar region based on matching the planar region with surface segments that are identified based on semantic segmentation and normal direction information. The semantic segmentation and normal direction information can be determined using machine learning on one or more images of the scene. The semantic segmentation and normal direction information is combined or otherwise used to determine surface segments, e.g., segments that have both similar semantic labels (e.g., floor, table, wall, etc.) and similar normal directions. These surface segments are then matched (e.g., in 3D space) with the initial planar regions. Given this matching, some or all of the surface segment is determined to be part of the same planar region and thus can be used to extend the plane. Other techniques disclosed herein extend planes based on stability determinations and identify vertical planes based on horizontal plane extents.

### CROSS-REFERENCE TO RELATED APPLICATIONS

This Application is a divisional of U.S. patent application Ser. No. 16/736,328 filed Jan. 7, 2020, which claims the benefit of U.S. Provisional Application Ser. No. 62/799,688 filed Jan. 31, 2019, which is incorporated herein in its entirety, and to U.S. Provisional Application Ser. No. 62/851,768 filed May 23, 2019, entitled “MACHINE LEARNING-SUPPORTED PLANE ESTIMATION,” each of which is incorporated herein in its entirety.

### TECHNICAL FIELD

The present disclosure generally relates to computer vision, and in particular, to systems, methods, and devices for implementing computer vision techniques that provide plane estimation in physical setting (e.g., scene) understanding.

### BACKGROUND

Various computer-based techniques are used to identify the locations of planar regions based on one or more images of a physical setting. For example, simultaneous localization and mapping (SLAM) techniques can provide 3D point locations based on matching texture (or other features) in images of a physical setting and these 3D points can be used to predict the location of floors, table surfaces, walls, ceilings, and other planar regions. However, because of the sparsity of 3D point locations predicted by SLAM and similar techniques (especially for portions of planar regions farther from the image capture device), the planar regions are often inadequate. The planar regions that are predicted are often relatively small, do not include the full extent of a planar region or its planar extents (e.g., boundaries), or require camera images from a variety of locations and positions in the physical setting. Existing techniques often fail to identify some of the planar regions in a physical setting, sufficiently large planar regions, or planar region extents that would be useful or are required for many applications.

### SUMMARY

In some implementations, a system or method is configured to extend a planar region that is detected by a SLAM technique or the like. In some implementations, two planar regions are determined and merged based on matching the normal directions or semantic labels associated with the two planar regions. For example, the planar regions may be merged based on determining that the normal directions and semantic labels match. In another example, the planar regions may be merged based on determining that the normal directions match and that the planar regions are within a threshold distance of one another. In another example, the planar regions may be merged based on determining that the normal directions match, the semantic labels match, and the planar regions are within a threshold distance of one another.

In some implementations, a planar region is extended based on matching the planar region with one or more other planar regions that are surface segments. The surface segments are identified based on semantic segmentation and normal direction information. The semantic segmentation and normal direction information can be determined using machine learning on one or more images of the scene. The semantic segmentation and normal direction information is combined or otherwise used to determine surface segments, e.g., segments that have both the same (or similar) semantic labels (e.g., floor, table, wall, etc.) and the same (or similar) normal directions. These surface segments are then matched (e.g., in 3D space) with the initial planar regions determined by SLAM or a similar technique. For example, SLAM may identify a small area on the surface of a table and the surface segments may include a segment that aligns with, overlaps, partially overlaps, or otherwise matches with that small area. Given this matching, some or all of the surface segment is determined to be part of the same planar region and thus can be used to extend the plane. In some implementations, planar region extensions are not added to a planar region until those possible planar region extensions are determined to be stable. For example, possible extension regions may be determined based on one or a few images. Based on later evaluation of an additional image or images confirming the initial determination, the extension regions can be determined to be stable and used to extend the initially determined planar region.

In some implementations, an electronic device having a processor performs a method. The method involves detecting a planar region of a three dimensional (3D) space corresponding to a plane of a surface in a physical setting. For example, this can involve using a SLAM technique to detect a planar region corresponding to a part of a floor or table. Only some of the floor/table surface relatively close to the image capture device may be detected. For example, in many cases some of the SLAM-detected 3D points, e.g., those points that are further from the image capture device, may be insufficient to identify portions of the surface that are further away as being part of the planar region. The method determines a surface segmentation based on a semantic segmentation and normal direction estimation of an image of the physical setting. The image may be obtained from an image capture device such as a RGB camera, RGB-D camera, an event camera, etc. The semantic segmentation and normal directions can be determined using machine learning, for example, using one or more neural networks that are trained to provide pixel-specific semantic labels or normal direction predictions. The method then determines a planar region extension based on matching the planar region and the surface segmentation. For example, the matching can involve determining that the planar region and surface segment align, overlap, partially overlap, have matching normal directions, or otherwise detecting that a surface segment is on a same plane and area as a planar region. In some implementations, the surface segment is divided into a grid of cells (e.g., rectangular units and the like) that are individually considered as possible extensions to the matching planar region. For example, initially the cells of a possible extension region can be cached until later observation/determination confirms that some or all of those cells are stable and thus can be added to the planar region.

Some implementations disclosed herein use a planar extent to identify a related planar region. For example, techniques identify another, second planar region based on a first, identified planar region. In some implementations, a new vertical plane is determined based on a vertical segment and an identified horizontal plane. For example, the new vertical plane may be determined based on a boundary between (1) a vertical segment identified based on semantics/normals and (2) a horizontal plane extent determined using SLAM or SLAM plus a plane extension technique, etc.

In some implementations, an electronic device having a processor performs a method. The method identifies a horizontal plane extent in a three dimensional (3D) space. The horizontal plane extent corresponds to a horizontal plane of a surface in a physical setting. Examples of a horizontal plane extent include, but are not limited to an estimation of the boundary around some or all of a floor area or an estimation of a boundary around some or all of a table top surface. A horizontal plane extent can be identified using SLAM or SLAM plus an extension technique disclosed herein. The method determines vertical segments in the 3D space based on a semantic segmentation of an image of the physical setting. In some implementations, a semantic segmentation is used to identify segments that are approximately vertical, e.g., regions of pixels that have the label “wall” may be considered vertical. In some implementations, the vertical segments are selected by picking segments that have normal directions that are roughly perpendicular to the horizontal planar region. The semantic segmentation and normal directions used for such determinations can be predicted using machine learning. The method determines a boundary between the horizontal plane extent and the vertical segments, selects a vertical segment based on the boundary, and constructs a vertical plane based on the selected vertical segment. The vertical segment that is most appropriate for creating a vertical plane associated with the boundary can be selected based on selection criteria, e.g., selection criteria favoring segments having a particular geometric relationship with (e.g., closest to) the boundary. If a plane has multiple touching boundaries to a candidate vertical plane, the method may determine to use only the closest boundary to compute the location of a vertical plane and select the vertical segment. In some implementations, the vertical segment that can be projected downward onto a line fitted to the boundary in 3D space is selected. The phrase “downward” in these examples refers to the direction of the plane that contains the boundary, e.g., the target plane's normal direction. For example, if a boundary belongs to the ground plane, downward should be the direction of the ground plane's normal. If more than one vertical segment can be projected onto the line, the vertical segment with the most projectable pixels is selected from those segments. Constructing the vertical plane from the vertical segment can involve computing 3D points from the pixels found on the vertical segment and constructing a plane using the computed 3D points.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a flowchart representation of a method of merging planar regions, in accordance with some implementations.

FIG. 2 is a block diagram illustrating determinations of portions of the first planar region that are within and outside of a threshold distance of the second planar region.

FIG. 3 is a flowchart representation of a method of extending a planar region corresponding to a plane of a surface in a physical setting, in accordance with some implementations.

FIG. 4 is a block diagram illustrating a device capturing an image of a physical setting.

FIG. 5 is a block diagram illustrating another view of the device of FIG. 2 capturing the image of the physical setting.

FIGS. 6A and 6B are block diagrams illustrating detecting plane(s) using SLAM 3D points in an image captured by the device of FIGS. 2 and 3.

FIG. 7 is a block diagram illustrating a technique for determining a surface segmentation using an image captured by the device of FIGS. 2 and 3.

FIG. 8 is a block diagram illustrating a technique for matching the individual surface segments with planes, if possible, and extending the planes using those surface segments based on an image captured by the device of FIGS. 2 and 3.

FIG. 9 is a block diagram illustrating dividing a planar region and possible surface extension into cells, in accordance with some implementations.

FIG. 10 is a flowchart representation of a method using a planar extent to identify a related planar region, in accordance with some implementations.

FIG. 11 is a block diagram illustrating a device capturing an image of a physical setting.

FIG. 12 is a block diagram illustrating another view of the device of FIG. 9 capturing the image of the physical setting.

FIG. 13 is a block diagram illustrating a technique for combining a surface segmentation and ground plane extent information to identify a ground extent and vertical surfaces using an image captured by the device of FIGS. 9 and 10.

FIG. 14 is a block diagram illustrating a technique for determining a line representing an edge or boundary between a ground extend and one or more vertical surfaces.

FIG. 15 is a block diagram illustrating a technique for determining a surface segmentation using an image captured by the device of FIGS. 9 and 10.

FIG. 16 is a block diagram illustrating a technique for matching a vertical surface of the surface segmentation with a line representing an edge or boundary between a ground extent and one or more vertical surfaces.

FIG. 17 is a block diagram illustrating a technique constructing a plane for a vertical surface.

FIG. 18 is a block diagram illustrating another exemplary plane estimation technique.

FIG. 19 is a block diagram of an example system architecture of an exemplary device in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

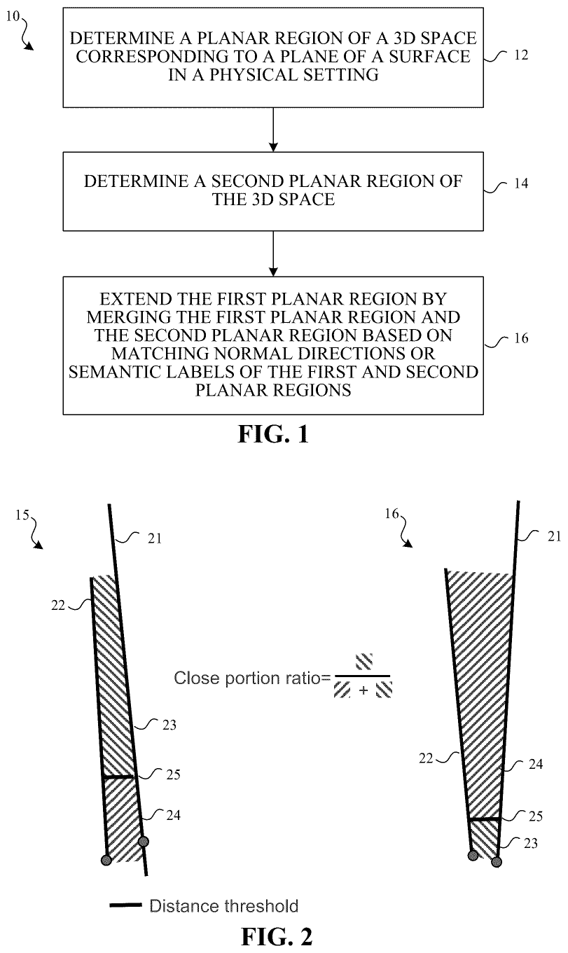

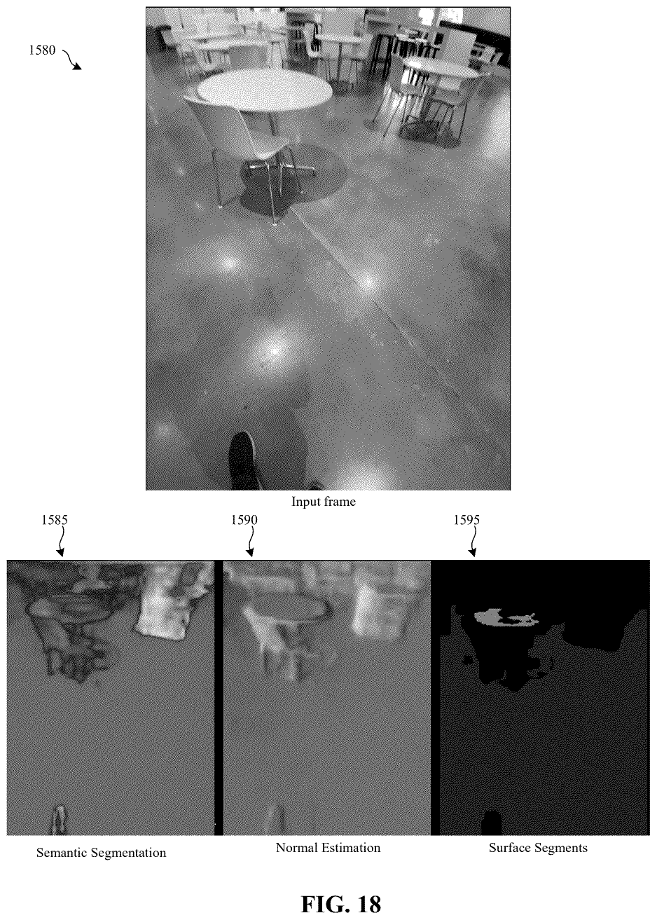

FIG. 1 is a flowchart representation of a method 10 of merging planar regions, in accordance with some implementations. In some implementations, the method 10 is performed by a device (e.g., device 1600 of FIG. 18). The method 10 can be performed at a mobile device, head mounted device (HMD), desktop, laptop, or server device. In some implementations, the method 10 is performed by processing logic, including hardware, firmware, software, or a combination thereof. In some implementations, the method 10 is performed by a processor executing code stored in a non-transitory computer-readable medium (e.g., a memory).

At block 12, the method 10 involves determining a first planar region of a 3D space corresponding to a plane of a surface in a physical setting. In some implementations, one or more planar regions are detected using a SLAM technique. In many instances, the planar surface that is detected will not include the full extent or boundaries of the real world plane in the physical setting that it represents. For example, the planar region may only represent a small portion of a floor, table top, ceiling, wall, etc.

At block 14, the method 10 involves determining a second planar region of the 3D space. In some implementations, the second planar region is a segment or other portion identified in a semantic segmentation. Such a semantic segmentation may be performed using machine learning or computer vision techniques and may produce one or more identified segments, each associated with a semantic label (e.g., table, chair, wall, etc.).

At block 16, the method 10 extends the first planar region by merging the first planar region and the second planar region based on matching normal directions or semantic labels of the first and second planar regions. In some implementations, the method 10 determines to extend the first planar region by merging with the second planar region based on matching both the normal directions and semantic labels of the first and second planar regions.

In some implementations, the method 10 determines to extend the first planar region by merging with the second planar region based on matching the normal directions of the first and second planar regions and determining portions of the first planar region that are within a threshold distance of the second planar region. Determining the portions of the first planar region that are within a threshold distance of the second planar region may involve determining first portions of the first planar region that are within the threshold distance of the second planar region, determining second portions of the first planar region that are outside of the threshold distance from the second planar region, and determining a ratio based on the first and second portions. In some implementations, determining to extend the first planar region is based on matching normal and semantic labels of the first and second planar regions and determining the portions of the first planar region that are within a threshold distance of the second planar region.

In some implementations, two planer regions are merged if they are sufficiently close to each other. In some implementations, whether two planes are sufficiently close to one another is determined based on a threshold plane-to-plane distance. In some implementations, the distance between planes is determined by identifying points (e.g., supporting points or plane origin points) for each plane and determining whether the point on either plane is within the threshold distance of the other plane.

In other implementations, instead of checking the distance between such points and the other planes, assessing plane-to-plane distance involves determining portions of the first planar region that are within a threshold distance of the second planar region. In one example, this involves determining a ratio of close plane portions to other/all plane portions.

FIG. 2 is a block diagram illustrating determinations of portions of the first planar region that are within and outside of a threshold distance of the second planar region. In a first example 15, two planar regions 21, 22 are illustrated from a top down perspective. The distance threshold 25 illustrates where the two planar regions 21, 22 are separated by the threshold distance. In example 15, portions 23 are within the threshold distance, while portions 24 are outside of the threshold distance. In example 15, a close portion ratio is determined: portions 23/(portions 23+portions 24). The method determines to merge the planar regions 21, 22 based on determining that ratio exceeds a threshold (e.g., 50%), indicating that more of the planar region 22 is close to the planar region 21 than is far from the planar region 21. In this example, the method would determine to merge the planar regions 21, 22.

In a second example 16, the two planar regions 21, 22 are again illustrated from a top down perspective and the distance threshold 25 is again used to illustrate where the two planar regions 21, 22 are separated by the threshold distance. In example 16, portions 23 are within the threshold distance, while portions 24 are outside of the threshold distance. In example 16, a close portion ratio is determined: portions 23/(portions 23+portions 24). The method determines to not merge the planar regions 21, 22 based on determining that ratio is less than a threshold (e.g., 50%), indicating that less of the planar region 22 is close to the planar region 21 than is far from the planar region 21.

In some implementations, determining to merge planar regions may involve use of a computer implemented algorithm. In one example, πᵢ={nᵢ, dᵢ} and πⱼ={nⱼ, dⱼ} are candidate planar regions for potential merger. The term “candidate” refers to the planar regions satisfying

$${n}_{i}^{T} \cdot {n}_{j} \geq cos θ .$$

In this example, a first step of the algorithm involves defining perpendicular spaces of πᵢ as π_{i,⊥}_{₁} and π_{i,⊥}_{₂}. Note that there are only two perpendicular spaces that exist for each plane in a 3D space. The first step may involve the follow elements:
(a) Project πᵢ onto π_{i,⊥}_{₁} to get the corresponding line segment l_{i,⊥}_{₁}.
(b) Project top-left and bottom-right corners of λⱼ onto π_{i,⊥}_{₁} and connect them to get line segment 1_{j,⊥}_{₁}.
(c) Compute the portion ρ_{i,⊥}_{₁} of l_{i,⊥}_{₁} that the distances from all possible points on this portion to l_{i,⊥}_{₁} is less than or equal to the distance threshold d.

(d) Repeat above procedures by replacing π_{i,⊥}_{₁} with π_{i,⊥}_{₂} to get ρ_{i,⊥}_{₂}.

The exemplary algorithm may involve a second step that repeats the first step while exchanging the roles of πᵢ and πⱼ to get ρ_{i,⊥}_{₁} and ρ_{i,⊥}_{₂}.

The exemplary algorithm may involve a third step that determines to merge the planar regions based on determining whether the following is true:

$$max ( \frac{l ( {ρ}_{i , {⊥}_{1}} )}{l ( {l}_{i}^{{π}_{i , {⊥}_{1}}} )} , \frac{l ( {ρ}_{i , {⊥}_{2}} )}{l ( {l}_{i}^{{π}_{i , {⊥}_{2}}} )} , \frac{l ( {ρ}_{j , {⊥}_{1}} )}{l ( {l}_{j}^{{π}_{j , {⊥}_{1}}} )} , \frac{l ( {ρ}_{j , {⊥}_{2}} )}{l ( {l}_{j}^{{π}_{j , {⊥}_{2}}} )} ) \geq r$$

where l(⋅) computes the length of line inside, and r is a ratio threshold. The point on lᵢ that the distance from it to lⱼ is exactly d is determined. The distance from a point on lᵢ to lⱼ can be represented as a linear function only depending on one coordinate, either x or y.

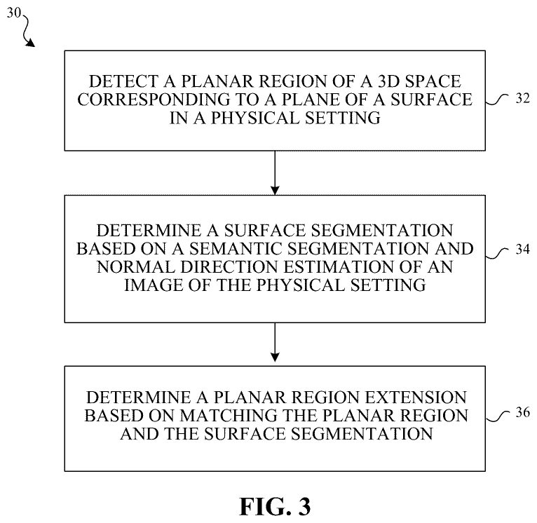

FIG. 3 is a flowchart representation of a method 30 of extending a planar region corresponding to a plane of a surface in a physical setting. In some implementations, the method 30 is performed by a device (e.g., device 1600 of FIG. 18). The method 30 can be performed at a mobile device, head mounted device (HMD), desktop, laptop, or server device. In some implementations, the method 30 is performed by processing logic, including hardware, firmware, software, or a combination thereof. In some implementations, the method 30 is performed by a processor executing code stored in a non-transitory computer-readable medium (e.g., a memory).

At block 32, the method 30 detects a planar region of a three dimensional (3D) space corresponding to a plane of a surface in a physical setting. In some implementations, one or more planar regions are detected using a SLAM technique. In many instances, the planar surface that is detected will not include the full extent or boundaries of the real world plane in the physical setting that it represents. For example, the planar region may only represent a small portion of a floor, table top, ceiling, wall, etc.

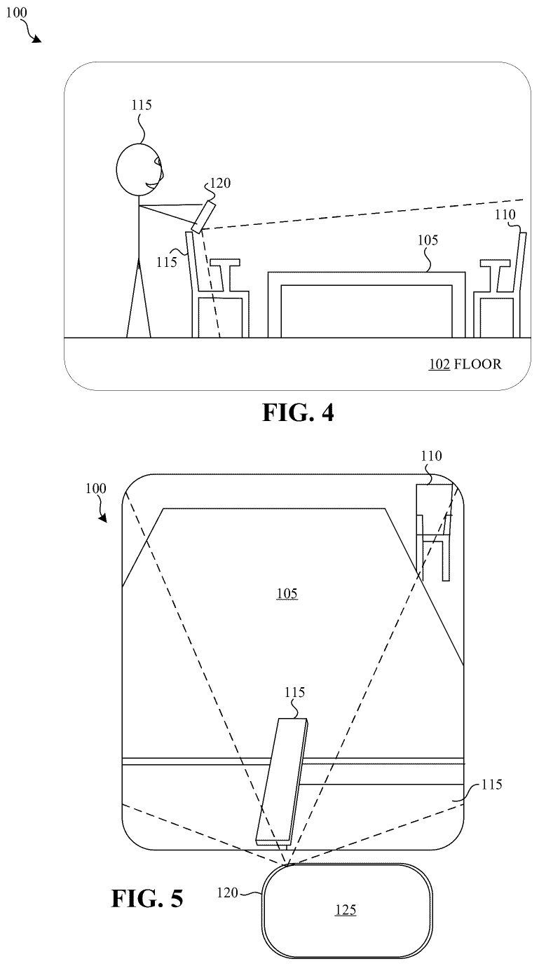

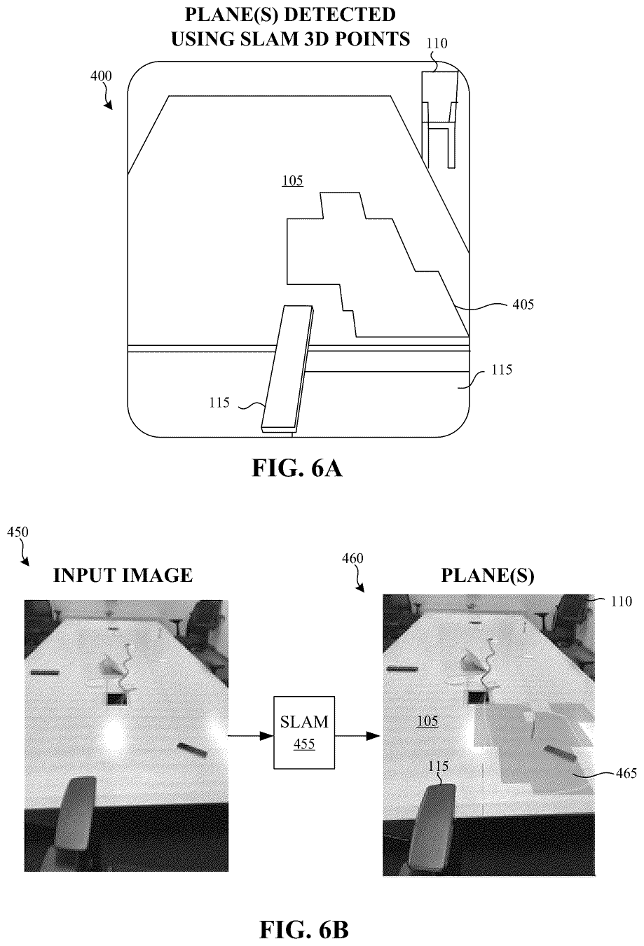

FIGS. 4, 5, 6A, and 6B illustrate an example of detecting a planar region. FIGS. 4 and 5 are block diagrams illustrating a user 115 using a device 120 to capture an image 125 of a physical setting 100. The physical setting 100 includes a floor 102, a table 105, a chair 110, and a chair 115. FIG. 6A is a block diagram illustrating an image 400 that identifies a planar region depiction 405 that was detected using a SLAM technique on image 125 (and possibly other images of the physical setting 100 from device 120). The planar region depiction 405 corresponds to a planar region that was identified in a 3D coordinate system based on 3D points determined by the SLAM technique. The planar region depiction 405 (and thus the corresponding planar region in 3D space) does not include all of the upper surface of table 105 or adequately represent the extents of that actual planar region in the physical setting 100. FIG. 6B depicts an input image 450 being processed by a SLAM module 455 to produce an output 460 that includes a planar region depiction 465, corresponding to a planar region depicted in the input image 450. The planar region depiction 465 (and thus the corresponding planar region in 3D space) does not include all of the upper surface of table 105 or adequately represent the extents of that actual planar region in the physical setting 100. In these examples, the planar regions provided at block 12 of FIG. 3 and illustrated by the planar region depictions 405, 465 of FIGS. 6A and 6B do not adequately represent the actual planar region of the surface of table 105 or its extents. As discussed below, additional blocks of method 30 of FIG. 3 extend the planar region (e.g., the 3D planar regions corresponding to planar region depictions 105, 465) to more accurately represent the actual planar region of a physical setting (e.g., to more accurately represent the surface of table 105 and its extents).

At block 34 in FIG. 3, the method 30 determines a surface segmentation based on a semantic segmentation and normal direction estimation of an image of the physical setting. The image (e.g., image 125 of FIG. 5 or image 450 of FIG. 6B) may have been obtained from an image capture device such as a camera and may be one of many images in a sequence of images or video frames. The semantic segmentation and normal direction estimates may be determined using machine learning, for example, using a neural network. A machine learning model, e.g., a neural network, can be trained using labelled training data. For example, training an exemplary machine learning model can use input images that are labelled/annotated with labelled semantics and for which depth information relative to image capture device pose is known. The depth information for the training data may be known, for example, based on the images having been captured with a RGB-D camera or using a depth sensor that gives distances from the sensor. The depth information can be used to determine/estimate normal directions. In some implementations, one or more machine learning models produces semantic label predictions (e.g., “wall”) and surface normal direction predictions (e.g., Nᵢⱼ) for each pixel corresponding to the pixels of an image of the physical setting. These pixels can be associated with 3D locations in a 3D coordinate system (e.g., the same 3D coordinate system in which the planar region produced by SLAM or another such technique is represented).

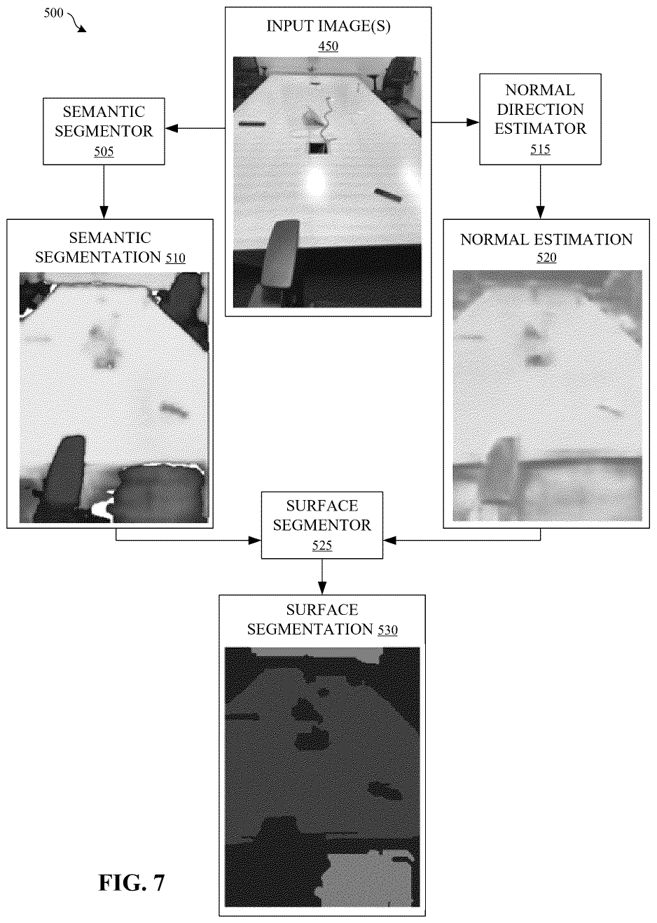

FIG. 7 illustrates an example of determining a surface segmentation using an image captured by the device of FIGS. 4 and 5. In this example, the input image(s) 450 are input to a semantic segmentor 505 to produce a semantic segmentation 510. The input images 450 are also input to a normal direction estimator 515 to produce a normal estimation 520. The semantic segmentation 510 and the normal estimation 520 are combined or otherwise used by surface segmentor 525 to produce surface segmentation 530.

The phrase “surface segmentation” as used herein refers to any combination of semantic segmentation with a normal direction estimation. In one example, a surface segmentation is an image that identifies pixels associated with a particular semantic label that also have the same or similar normal directions. In one example, pixels semantically labeled “table” corresponding to a top surface of a table would be treated as one surface segment while pixels semantically labelled “table” corresponding to a side of the table would be treated as a different surface since normal directions of the first set of pixels would be substantially different from the normal directions of the second set of pixels.

Returning to FIG. 3, at block 36, the method 30 determines a planar region extension based on matching the planar region and the surface segmentation. For example, the planar region and a surface segment may be matched with one another based on overlapping, partially overlapping, association with common or similar directional vectors, association with common or similar normal directions, or any other appropriate criteria indicative of a planar region and surface segment being a part of the same planar surface (e.g., wall, table top, ceiling, floor, etc.). In some implementations, this can involve determining whether there is overlapping in a 2D space to which the planar regions are projected. Use of a 2D-based assessment may be appropriate, for example, if the surface segments do not have 3D information associated, e.g., where no depth camera data is available. In other implementations, the matching can involve comparison in a 3D space. 3D locations of surface segments, planar regions, or other features may be determined from image capture device space to a common 3D coordinate system using capture device intrinsic and extrinsic information or using a depth camera (e.g., structured light sensor or time-of-flight sensor).

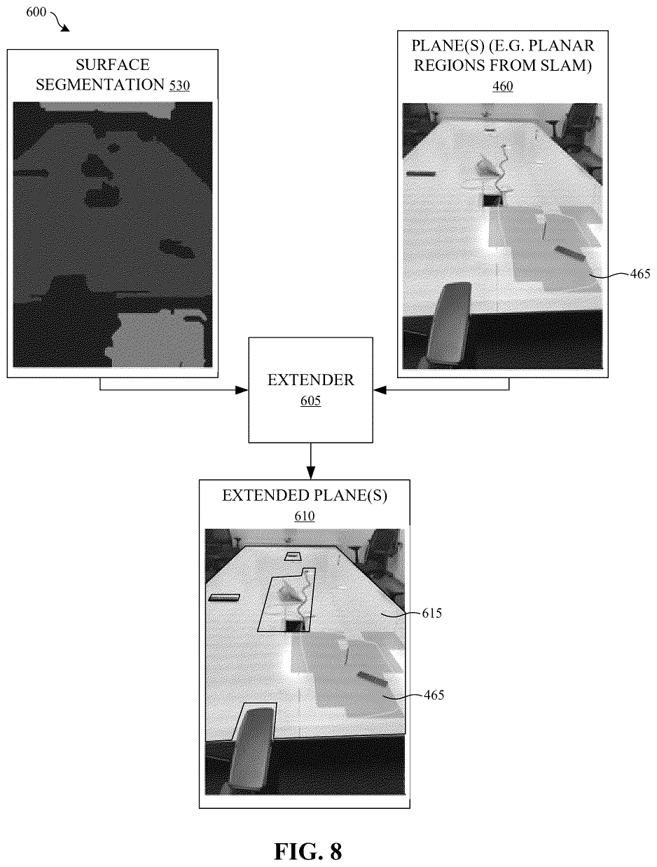

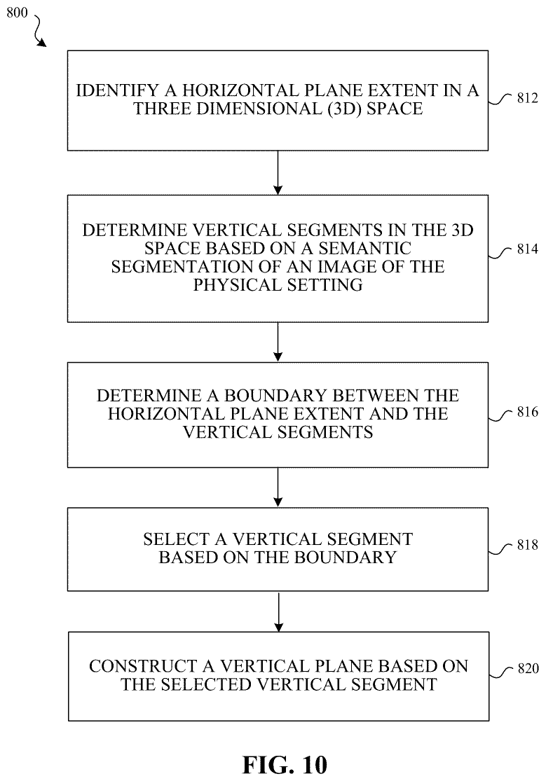

FIG. 8 illustrates an example of matching the individual surface segments with planes and extending the planes using those surface segments. In this example, the surface segmentation 530, which was determined in FIG. 7, and the planar region(s), which was depicted in FIG. 6B, are input together to a matcher/extender 605 that matches the individual surface segments of surface segments 530 with individual planes 460 and produces extended plane(s) 610 as output. The extended plane(s) 610 that are output, in this example, include an extended plane (e.g., in a 3D space) that is depicted by extended plane depiction 615 in FIG. 10. The extended plane depicted by extended plane depiction 615 better represents the actual planar region of the surface of table 105 (FIGS. 4-5) than the planar region depicted by planar region depiction 465. In other words, the initial planar region that was provided at block 10 of FIG. 3 (e.g., by a SLAM technique) has been extended to more accurately represent the actual planar surface in the physical setting 100 (FIG. 3).

In some implementations, the planar region extension (or portions thereof) are determined gradually over a series of multiple images. For example, a possible planar region extension (or portion thereof) determined from one or a few images can be confirmed or otherwise considered stable based on subsequent consistent determinations made using additional images. In some implementations, determining the planar region extension involves identifying a portion (e.g., a cell) of the surface segmentation as a possible extension of the planar region, storing (e.g., caching) the portion prior to extending the planar region with the portion, and later extending the planar region based on a subsequent image of the physical setting (e.g., extending the plane once the cached observation becomes consistent). A planar region extension can include a grid of cells associated with varying degrees or indications of confidence (e.g., cells identified as part of the planar region in 3 or more frames, cells identified as part of the planar region in 2 frames, cells identified as part of the planar region in only 1 frame). These confidence values can be used to determine whether to treat a given cell as part of the planar region or not for a given purpose.

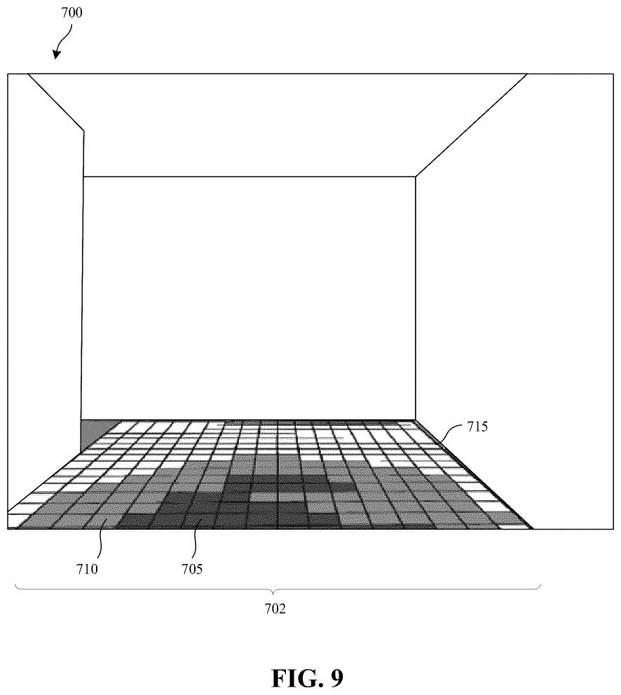

FIG. 9 illustrates dividing a planar region 702 (e.g., the floor planar region of the room 700) into cells. Initial planar region cells 705 represent an initial planar region, such as a planar region determined by a SLAM technique. Stable cells 710 represent planar region extension cells that have been determined stable based on stability criteria (e.g., criteria that accounts for the number of determinations that confirm a given cell is part of the planar surface, distance from image capture device, status of adjacent cells, etc.). Possible planar region cells 715 represent planar region extension cells that have been identified as possible extensions of the planar surfaces but have not yet satisfied the stability criteria. As additional images are obtained and additional determinations of planar region extensions are made, some or all of the possible planar region cells 715 may be determined to satisfy the stability criteria and thus may be converted to be stable cells and added to the model of the planar region.

Once determined stable, the planar region extensions (or cells or other portions thereof) may be provided to enhance a 3D model of the physical setting. In some implementations, a SLAM technique or other technique is used to provide a model that has an initial planar region and possible region extensions (or cells or other portions thereof) are determined using the method 30, and then provided to update the model. In some implementations, planar region extensions (or cells or other portions thereof) are only provided to update the model after being determined stable based on one or more stability criteria (e.g., minimum number of images confirming, distance from image capture device, etc.).

FIG. 10 is a flowchart representation of a method 800 using a planar extent to identify a related planar region, in accordance with some implementations. In some implementations, the method 800 is performed by a device (e.g., device 1600 of FIG. 18). The method 800 can be performed at a mobile device, head mounted device (HMD), desktop, laptop, or server device. In some implementations, the method 800 is performed by processing logic, including hardware, firmware, software, or a combination thereof. In some implementations, the method 800 is performed by a processor executing code stored in a non-transitory computer-readable medium (e.g., a memory). In some implementations, the method 800 is performed on the same device as the method 30 of FIG. 3 as part of a combined process.

At block 812, the method 800 identifies a horizontal plane extent in a three dimensional (3D) space. The horizontal plane extent corresponds to a horizontal plane of a surface in a physical setting, e.g., the boundary of a floor, the boundary of a table top surface, the boundary of a ceiling, etc. In some implementations, the horizontal plane extent is determined based on a planar region detected using a SLAM technique. In some implementations, the horizontal plane extent is determined by extending a planar region using one or more of the planar region extension techniques disclosed herein, e.g., using method 30 of FIG. 3 to extend a SLAM-based horizontal planar region.

At block 814, the method 800 determines vertical segments in the 3D space based on a semantic segmentation of an image of the physical setting. The image may be obtained from an image capture device. The semantic segmentation may be used to identify segments that are approximately vertical, e.g., regions of pixels that have the label “wall” may be considered vertical. The vertical segments may be selected by automatically selecting segments that have normal directions that are perpendicular to the horizontal plane. The semantic segmentation and normal directions can be determined using machine learning as discussed above.

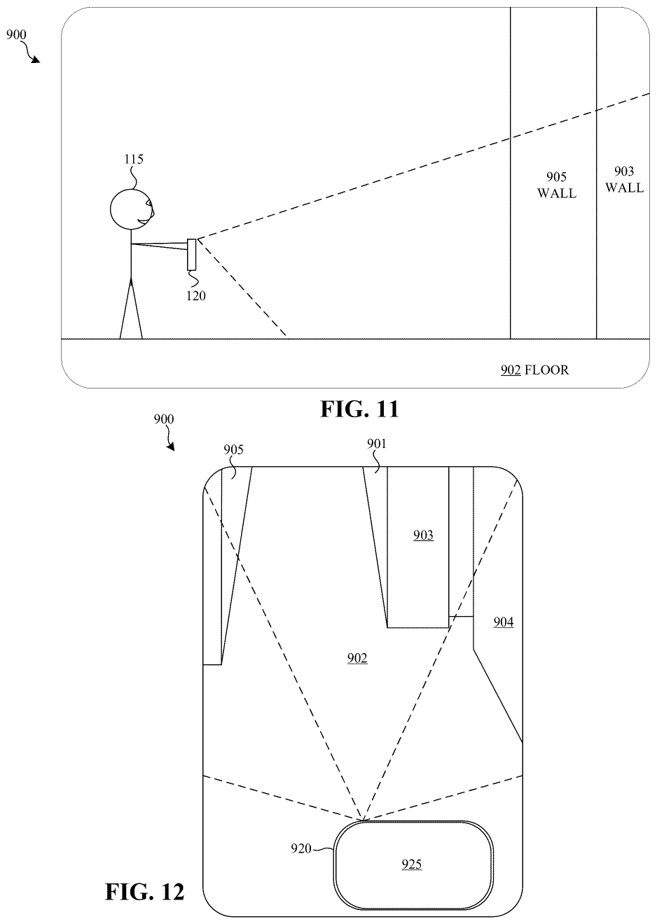

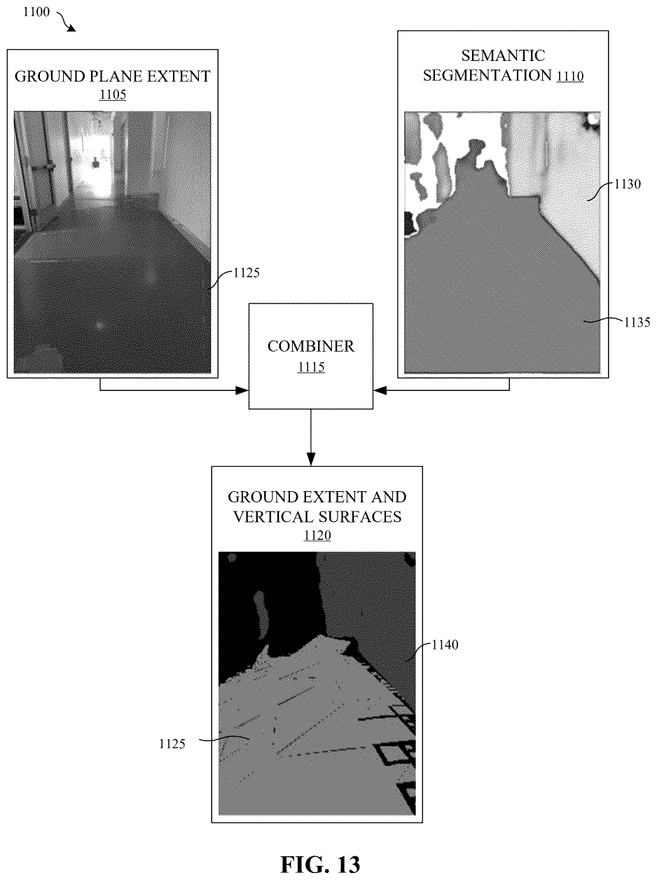

FIGS. 11, 12, and 13 illustrate an example of identifying vertical segments based on semantic segmentation and ground plane extents. FIGS. 11 and 12 are block diagrams illustrating a user 115 using a device 120 to capture an image 925 of a physical setting 900. The physical setting 900 includes a floor 902 and walls 904, 903, 905. FIG. 13 is a block diagram illustrating using two inputs determined from the image 925 in a method 1100 that produces a ground extent and vertical surfaces 1120. The first input is a ground plane extent 1105 represented by the ground plane extent depiction 1125, which may have been determined using a SLAM technique, an extension technique such as method 30 of FIG. 3, or any other technique from which the extents or boundaries of a horizontal plane can be determined. The second input is a semantic segmentation 1110, which includes, in this example, a region of pixels 1130 labelled “wall” and a region of pixels 1135 labelled “floor.” In FIG. 5, these inputs are combined by combiner 1115 to produce ground extent and vertical surfaces 1120, which are depicted in an image showing the ground extent 1125 and vertical segments 1140.

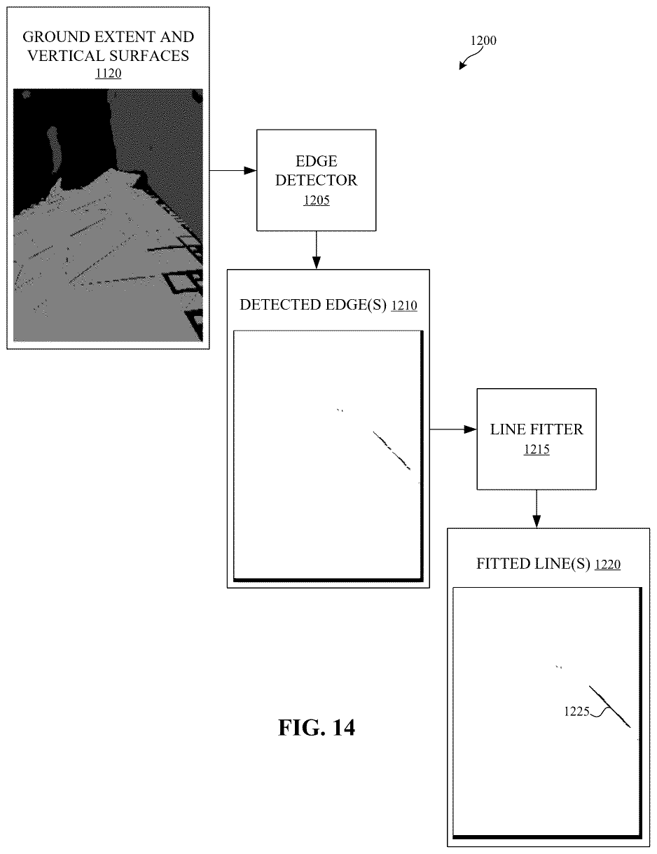

Returning to FIG. 10, at block 816, the method 800 determines a boundary between the horizontal plane extent and the vertical segments. FIG. 14 illustrates an exemplary technique 1200 for determining a line representing an edge or boundary between a ground extent and one or more vertical surfaces. In this example, the ground extent and vertical surfaces 1120 are input to an edge detector 1205 that detects detected edge(s) 1110, for example, based on pixel characteristics of an image representing the ground extent and vertical surfaces. The edge detector 1205 can apply a machine learning model, e.g., a neural network, to detect the edges. In one example, the edge detector examines pixels or 3D points on or near the extent/boundary of the horizontal plane and identifies a subset based on additional content such as other pixels or 3D points. Any appropriate known or to-be-developed edge detection technique can be used. The detected edges 1210 are input to a line fitter 1215 that produces fitted line(s) 1220, for example, producing fitted line 1225 based on identified points on and edge in the detected edge(s) 1210.

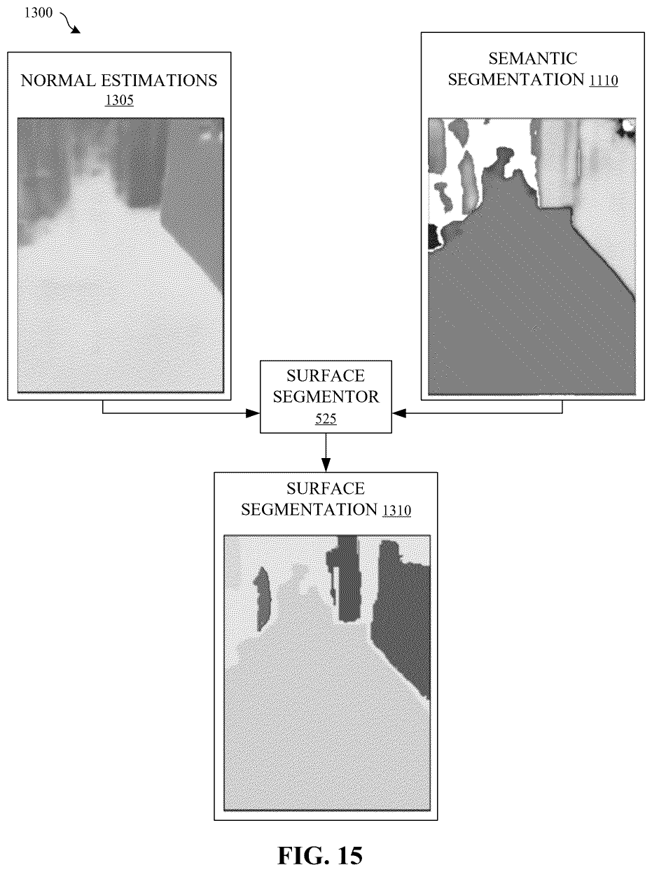

At block 818, the method 800 selects a vertical segment of the vertical segments based on the boundary. The selected vertical segment will ultimately be used to construct a vertical plane. In some implementations, selecting the vertical segment involves identifying surface segments via a surface segmentation and then identifying a segment that is most appropriate for the boundary, e.g., has a particular geometric relationship with the boundary. FIG. 15 illustrates an exemplary technique 1300 for determining a surface segmentation. In this example, a semantic segmentation 1110 and a normal estimation 1305 are combined or otherwise used to by surface segmentor 525 to produce surface segmentation 1310. Some of the segments of surface segmentation 1310 may be vertical segments and may be identified as such based on their having semantic labels associated with vertical surfaces, e.g., “wall,” “television,” “window,” etc.

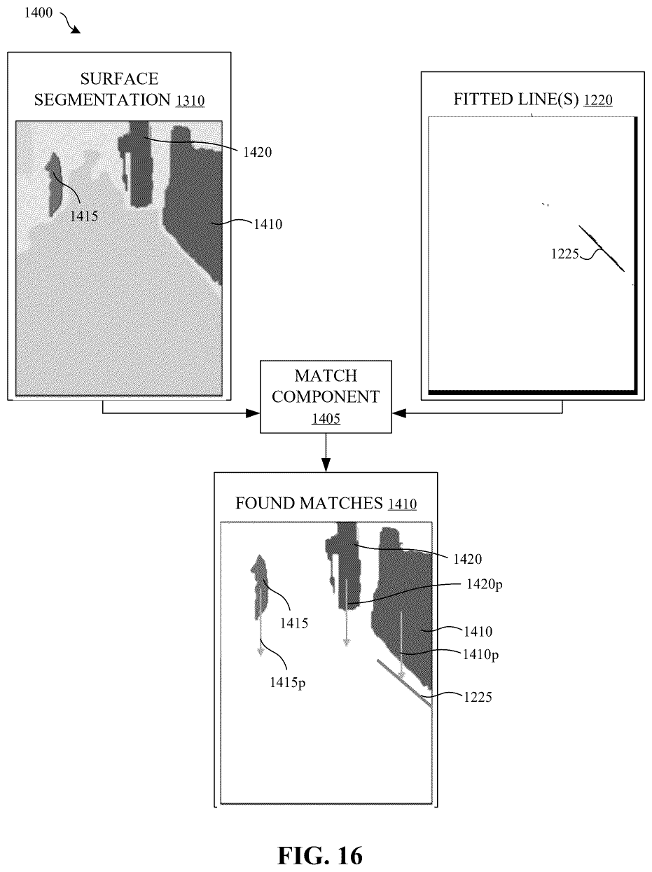

One or more of these vertical segments is selected for a given boundary. FIG. 16 illustrates an exemplary technique 1400 for matching a vertical surface of a surface segmentation with a line representing an edge or boundary between a ground extent and one or more vertical surfaces. In some implementations, selecting the vertical segment involves determining a projection by projecting the vertical segment downward and identifying an intersection of the projection with a line fitted to the boundary. As mentioned above, the phrase “downward” in these examples refers to the direction of the plane that contains the boundary, e.g., the target plane's normal direction. For example, if a boundary belongs to the ground plane, the downward should be the direction of the ground plane's normal. In the example of FIG. 16, the surface segmentation 1310 and fitted line(s) 1220 are input to a match component 1405 to select vertical segments for each of the one or more found lines. Specifically, the surface segmentation 1310 includes vertical segments 1410, 1415, 1420 and the fitted lines include fitted line 1225. The match component 1405 determines projections 1410p, 1415p, and 1420p for each of the vertical segments 1410, 1415, and 1420 respectively. The match component 1405 determines that the projection 1410p for vertical segment 1410 intersects the fitted line 1225 and thus selects this vertical segment 1410 for use in constructing the vertical plane.

If more than one vertical segment can be projected downward onto the line or otherwise matches, one of those vertical segments can be selected based on additional selection criteria, for example, selecting the vertical segment having the most projectable pixels, e.g., the largest area. Accordingly, selecting the vertical segment can involve determining projections of multiple vertical segments, identifying a set of vertical segments of the multiple vertical segments having projections that intersect with a line fitted to the boundary, and selecting a vertical segment of the set based on number of pixels in the vertical segment.

Returning to FIG. 10, at block 820, the method 800 constructs a vertical plane based on the selected vertical segment. In some implementations, this involves computing 3D points from the pixels found on the vertical segment and constructing the vertical plane (and its extents/boundaries) using the computed 3D points. The boundary or fitted line(s) can be used in constructing the vertical plane. For example, a vertical segment may be extended to occupy an area between its original boundaries and the fitted line to which it is determined to be associated.

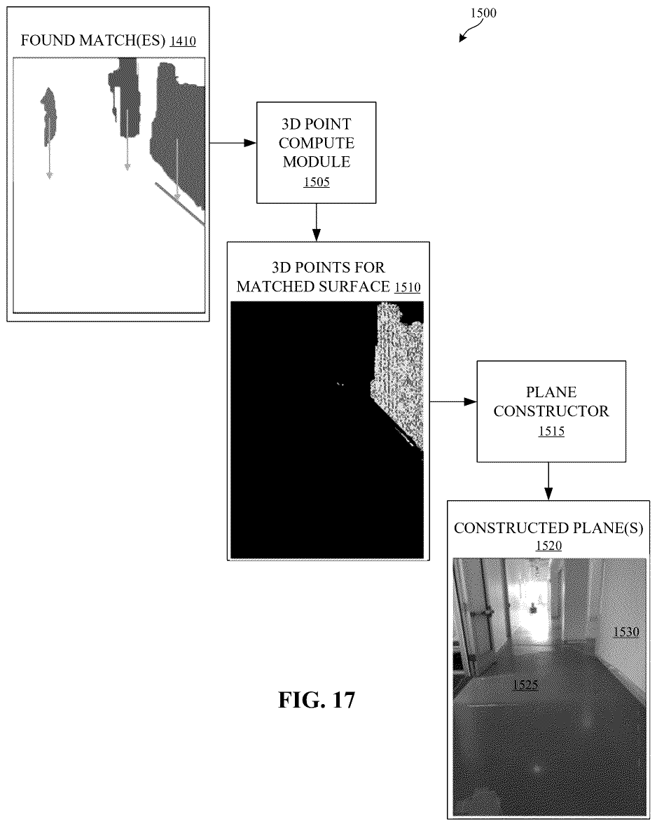

FIG. 17 illustrates a technique 1500 for constructing a plane for a vertical surface. In this example, the found match(es) 1410 (e.g., the vertical segment(s) that matches a given boundary of the horizontal plane) is input to a 3D point compute module 1505. The 3D point compute module computes 3D points for a matched surface 1510. Those 3D points for the matched surface 1510 are input to a plane constructor 1515 that constructs constructed plane(s) 1520 such as vertical plane 1530. The resulting model provides the positions (e.g., in an image or in 3D space) of both horizontal and vertical planes, e.g., of both horizontal plane 1525 and vertical plane 1530.

FIG. 18 is a block diagram illustrating another exemplary plane estimation technique. In FIG. 18, input frame 1580 is obtained and semantic segmentation 1585, normal estimation 1590, and surface segmentation 1595 are generated. For each surface segment, if the majority of belonging points agree with the same plane model, a plane is created. The created plane's extent is equal to the range of the surface segment. A 3D plane can be computed, as well, using the plane model. If this is too aggressive, the range of the extent can be limited, e.g., 5 meters from the current camera position.

While some implementations disclosed herein are based on an assumption that an observed plane is already available, in other implementations, an algorithm is used to find planes using surface segments without requiring other observed planes. For example, a very sparse set of 3D points (e.g., detected using SLAM or the like) may be obtained. There can be many reasons that the points are sparse. For example, the physical environment may not contain sufficient texture, the image resolution may be too low, or an ultra-wide angle may result in sparse points. In some implementations, surface segments are obtained using ML-estimated semantic labels and normals of an image. For each surface segment, 3D points may be gathered by projecting them onto the image containing the surface segments. With the gathered points, the plane model may be hypothesized using, for example, RANSAC. If the significant portion of the points belongs to the hypothesized plane model, a plane may be created with the same extent as the belonging surface segment. A more advanced or sophisticated strategy may be applied to determine whether or not to take a plane from the surface segment.

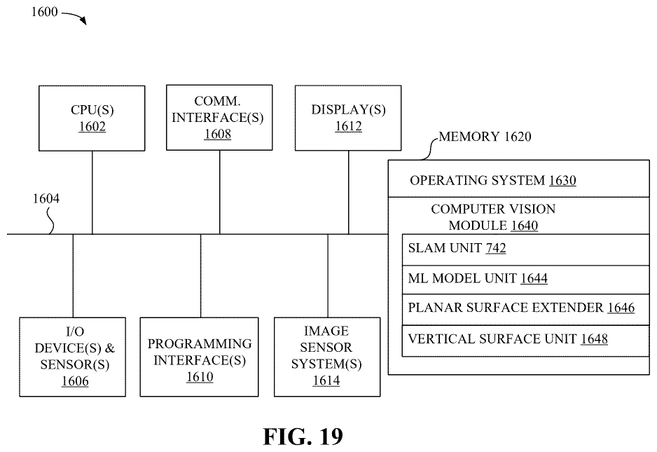

FIG. 19 is a block diagram of an example system architecture of an exemplary device configured to facilitate computer vision tasks in accordance with one or more implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1600 includes one or more processing units 1602 (e.g., microprocessors, ASICs, FPGAs, GPUs, CPUs, processing cores, or the like), one or more input/output (I/O) devices and sensors 1606, one or more communication interfaces 1608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, or the like type interface), one or more programming (e.g., I/O) interfaces 1610, one or more displays 1612, one or more interior or exterior facing image sensor systems 1614, a memory 1620, and one or more communication buses 1604 for interconnecting these and various other components.

In some implementations, the one or more communication buses 1604 include circuitry that interconnects and controls communications between system components. In some implementations, the one or more I/O devices and sensors 1606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), or the like.

In some implementations, the one or more displays 1612 are configured to present images from the image sensor system(s) 1614. In some implementations, the one or more displays 1612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), or the like display types. In some implementations, the one or more displays 1612 correspond to diffractive, reflective, polarized, holographic, etc. waveguide displays. For example, the device 1600 includes a single display. In another example, the device 1600 is a head-mounted device that includes a display for each eye of the user.

The memory 1620 includes high-speed random-access memory, such as DRAM, SRAM, DDR RAM, or other random-access solid-state memory devices. In some implementations, the memory 1620 includes non-volatile memory, such as one or more magnetic disk storage devices, optical disk storage devices, flash memory devices, or other non-volatile solid-state storage devices. The memory 1620 optionally includes one or more storage devices remotely located from the one or more processing units 1602. The memory 1620 comprises a non-transitory computer readable storage medium. In some implementations, the memory 1620 or the non-transitory computer readable storage medium of the memory 1620 stores the following programs, modules and data structures, or a subset thereof including an optional operating system 1630 and a computer vision module 1640.

The operating system 1630 includes procedures for handling various basic system services and for performing hardware dependent tasks. In some implementations, the computer vision module 1640 is configured to facilitate a computer vision task. The SLAM unit is configured to provide simultaneous localization and mapping using one or more images. The machine learning model unit 1644 is configured to train and or use one or more machine learning models to perform semantic segmentation, normal direction estimation, or other computer vision task, for example, using one or more images. The planar surface extender unit 1646 is configured to extend a planar region, for example, using the method 30 of FIG. 3. The vertical surface unit 1648 is configured to determine a vertical surface based on a horizontal surface extend, for example, using the method 800 of FIG. 8. Although these modules and units are shown as residing on a single device (e.g., the device 1600), it should be understood that in other implementations, any combination of the these modules and units may be located in separate computing devices.

Moreover, FIG. 18 is intended more as a functional description of the various features which are present in a particular implementation as opposed to a structural schematic of the implementations described herein. As recognized by those of ordinary skill in the art, items shown separately could be combined and some items could be separated. For example, some functional modules and units shown separately in FIG. 18 could be implemented in a single module or unit and the various functions of single functional blocks could be implemented by one or more functional blocks in various implementations. The actual number of modules and units and the division of particular functions and how features are allocated among them will vary from one implementation to another and, in some implementations, depends in part on the particular combination of hardware, software, or firmware chosen for a particular implementation.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the terms “or” and “and/or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations, but according to the full breadth permitted by patent laws. It is to be understood that the implementations shown and described herein are only illustrative of the principles of the present invention and that various modifications may be implemented by those skilled in the art without departing from the scope and spirit of the invention.

What is claimed is:

1. A method, comprising:
at an electronic device having a processor:
identifying a horizontal plane extent in a three dimensional (3D) space, the horizontal plane extent corresponding to a horizontal plane of a surface in a physical setting;
determining vertical segments in the 3D space based on a semantic segmentation of an image of the physical setting, the image obtained from an image capture device;
determining a boundary between the horizontal plane extent and the vertical segments;
selecting a vertical segment of the vertical segments based on the boundary; and
constructing a vertical plane based on the selected vertical segment.

2. The method of claim 1, wherein the vertical segments are determined by identifying regions of pixels having semantic labels corresponding to vertical surfaces.

3. The method of claim 1, wherein the vertical segments are determined by selecting regions of pixels having normal directions that are perpendicular to the horizontal plane extent.

4. The method of claim 1, wherein the semantic segmentation and normal directions are determined using machine learning.

5. The method of claim 1, wherein selecting the vertical segment comprises identifying which vertical segment has a particular geometric relationship with the boundary.

6. The method of claim 1, wherein selecting the vertical segment comprises determining a projection by projecting the vertical segment downward and identifying an intersection of the projection with a line fitted to the boundary.

7. The method of claim 6, wherein selecting the vertical segment comprises:
determining projections of multiple vertical segments;
identifying a set of vertical segments of the multiple vertical segments having projections that intersect with a line fitted to the boundary; and
selecting a vertical segment of the set based on number of pixels in the vertical segment.

8. The method of claim 1, wherein constructing the vertical plane comprises computing 3D points from pixels on the vertical segment and constructing the vertical plane based on the computed 3D points.

9. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
identifying a horizontal plane extent in a three dimensional (3D) space, the horizontal plane extent corresponding to a horizontal plane of a surface in a physical setting;
determining vertical segments in the 3D space based on a semantic segmentation of an image of the physical setting, the image obtained from an image capture device;
determining a boundary between the horizontal plane extent and the vertical segments;
selecting a vertical segment of the vertical segments based on the boundary; and
constructing a vertical plane based on the selected vertical segment.

10. The system of claim 9, wherein the vertical segments are determined by identifying regions of pixels having semantic labels corresponding to vertical surfaces.

11. The system of claim 9, wherein the vertical segments are determined by selecting regions of pixels having normal directions that are perpendicular to the horizontal plane extent.

12. The system of claim 9, wherein the semantic segmentation and normal directions are determined using machine learning.

13. The system of claim 9, wherein selecting the vertical segment comprises identifying which vertical segment has a particular geometric relationship with the boundary.

14. The system of claim 1, wherein selecting the vertical segment comprises determining a projection by projecting the vertical segment downward and identifying an intersection of the projection with a line fitted to the boundary.

15. The system of claim 14, wherein selecting the vertical segment comprises:
determining projections of multiple vertical segments;
identifying a set of vertical segments of the multiple vertical segments having projections that intersect with a line fitted to the boundary; and
selecting a vertical segment of the set based on number of pixels in the vertical segment.

16. The system of claim 9, wherein constructing the vertical plane comprises computing 3D points from pixels on the vertical segment and constructing the vertical plane based on the computed 3D points.

17. The system of claim 9, wherein determining the planar region extension comprises:
identifying a portion of the surface segmentation as a possible extension of the planar region;
storing the portion prior to extending the planar region with the portion; and
extending the planar region based on a subsequent image of the physical setting.
